(19) United States
(12) Patent Application Publication
(10) Pub. No.: US 2012/0203725 A1
(43) Pub. Date: Aug. 9, 2012

(54) AGGREGATION OF BIO-SIGNALS FROM MULTIPLE INDIVIDUALS TO ACHIEVE A COLLECTIVE OUTCOME

(75) Inventor: Adrian Stoica, Altadena, CA (US)

(73) Assignee: California Institute of Technology, Pasadena, CA (US)

(21) Appl. No.: 13/354,207

(22) Filed: Jan. 19, 2012

Related U.S. Application Data
(60) Provisional application No. 61/434,342, filed on Jan. 19, 2011.

(51) Int. Cl. G06N 5/02

(52) U.S. Cl. 706/46

(57) ABSTRACT

Systems and methods for generating results of observations of signals acquired from by groups, including humans, animals, living matter in vitro and machines as members of a group. In some embodiments, the signals are EEG, EMG, EOG or other signals from a biologically active source. The signals are categorized by various criteria, and can be quantified. The categorized signals are combined to produce a result. The result can be displayed to a user, recorded, fed back to one or more signal sources, or used in further information processing.

### CROSS-REFERENCE TO RELATED APPLICATIONS

This application claims priority to and the benefit of co-pending U.S. provisional patent application Ser. No. 61/434,342 filed Jan. 19, 2011, which application is incorporated herein by reference in its entirety.

### STATEMENT REGARDING FEDERALLY FUNDED RESEARCH OR DEVELOPMENT

The invention described herein was made in the performance of work under a NASA contract, and is subject to the provisions of Public Law 96-517 (35 USC 202) in which the Contractor has elected to retain title.

### FIELD OF THE INVENTION

The invention relates to signal processing in general and particularly to systems and methods that involve processing signals from multiple sources.

### BACKGROUND OF THE INVENTION

A decision in which more than one person (e.g., a group or a team) is involved in the decision process often results in a superior decision as compared to one made by a single individual. We develop committees, procedures and voting means to reach joint decisions. Joint decision-making from presented information is needed in many tactical situations, from rapid assessment of vulnerability threats to immediate engagement of targets. In social or political contexts its broadest impact would be expressions of votes cast in elections. Leaving aside democratic rationale, and focusing on the utility of joint decisions for solving complex problems, there are a number of benefits, including the advantage of analyzing a problem from multiple facets, that are made possible by diversity of expertise in different individuals, some of whom may be experts, and benefiting from the power of many when analysis and information processing can be shared.

Conventional joint analysis and decision making is naturally limited by several factors. They include:

### Communication Bottlenecks

Optimal joint decisions require information exchange. However, conventional (mostly verbal) communication means severely limit the rate at which such information can be exchanged (limited throughput), and are unable to completely and exactly convey the entire spectrum of information contained in the human mind.

### Processing Bottlenecks in Single Brains

Humans have a limited capacity for attention, and this severely limits conscious perception and consequently the amount of information processed at any particular time, including the possibility that important information left at the unconscious level is neglected.

One of the implications is that when individuals focus on some tasks, they often fail to perceive unexpected objects, even if they appear at fixation. This phenomenon is known as inattentional blindness and has been demonstrated through the famous “invisible gorilla” experiment. In this test, subjects are asked to watch a short video in which two groups of people (wearing black and white t-shirts) pass a basketball around. The subjects are told to count the number of passes made by the group wearing white t-shirts. Halfway through the video, a man wearing a full gorilla suit walks through the scene. After watching the video the subjects are asked if they saw anything out of the ordinary take place. It has been shown that approximately 50% of the subjects taking this test fail to notice the gorilla.

Also, humans have a limited capacity to store information, and they can only remember about 4-6 “chunks” in short-term memory tasks.

### Aggregation Methodologies Bottlenecks

In many scenarios the time for discussion of everyone's perspective on the matter to be decided is minimal. In such situations, rapid binary Yes/No individual votes may be aggregated to obtain the final decision, yet this is known to lead to suboptimal collective decisions.

For example assume 3 people, with their point-measure feelings towards voting PRO/CON being: (1) 51/49, (2) 51/49, and (3) 0/100. If the decision-making process is based on aggregating binary votes (ABV), 51/49 rounds to PRO, 0/100 to CON, and there are 2 PRO and 1 CON, resulting in PRO. If the process is based on aggregating fine information (AFI) on each criterion first, i.e. all points for PRO and CON are first counted and then the option with more points is selected, then there would be 102 points for PRO and 198 points for CON, hence resulting in CON. The ABV method is more volatile, and a small change in feelings/points could easily change the result (e.g., when aggregating binary votes a 2 point change in one voter from 51/49 to 49/51 would switch his decision from PRO to CON, and hence flip the overall decision from PRO to CON). A 2 point change in the AFI method will not change the outcome. Another way to justify this is to say that the ABV method truncates/eliminates information prematurely.

### Inaccuracies in Expression/Communication of Internal Analysis or Judgments

Even when there is time to communicate, humans tend to misrepresent the level of certainty about their individual determinations, and this severely degrades the quality of the joint decisions.

For example, assume that two referees have to decide whether a soccer ball has crossed the goal line. Let dᵢ be the distance of the ball from the goal line as estimated by referee i, and sᵢ be the associated standard deviation. To achieve a joint determination, humans apparently communicate dᵢ/sᵢ, even though the optimal strategy would be to communicate dᵢ/sᵢ². The result is, in general, a suboptimal joint decision.

Brain signals are known to be useful. EEG was shown to be indicative of emotions (e.g. [MUR 2008]), and at least simple intelligent controls are possible from EEG as have been used by several groups including a group at the Jet Propulsion Laboratory that has used EEG for robot control.

State of the art communication interfaces allow connecting individual human brains to a computer; most popular non-invasive brain-computer interfaces rely on Electroencephalography (EEG), which records brain correlates such as Slow Cortical Potentials (SCP) (see N. Neumann, A. Kübler, et al., Conscious perception of brain states: mental strategies for brain-computer communication. Neuropsychologia, 41(8):1028-1036, 2003; U. Strehl, U. Leins, et al., Self-regulation of Slow Cortical Potentials: A New Treatment for Children With Attention-Deficit/Hyperactivity Disorder. Pediatrics, 118:1530-1540, 2006.), Sensorimotor Rhythms (see G. Pfurtscheller, G. R. Muller-Putz, et al., 15 years of BCI research at Graz UT current projects. Neural Systems and Rehabilitation Engineering, IEEE Trans on, 14(2):205-210, June 2006), or the P300 component of Event-related Potentials (see M. Thulasidas, Cuntai Guan, and Jiankang Wu. Robust classification of EEG signal for brain-computer interface. Neural Systems and Rehab Engineering, IEEE Trans, 14(1):24-29, March 2006). Other techniques include Magnetoencephalography (MEG) (see L. Kauhanen, T. Nykopp, et al., EEG and MEG brain-computer interface for tetraplegic patients. Neural Systems and Rehabilitation Engineering, IEEE Transactions on, 14(2):190-193, June 2006), and functional Magnetic Resonance Imaging (fMRI) (see Y. Kamitani and F. Tong. Decoding the visual and subjective contents of the human brain. Nature Neuroscience, 8:679-685, 2005). These techniques have been successfully applied to detect brain signals that correlate with motor imagery (e.g., left vs. right finger movement—see B. Blankertz, G. Dornhege, et al., The Berlin brain-computer interface: EEG-based communication without subject training. Neural Systems and Rehabilitation Engineering, IEEE Transactions on, 14(2):147-152, June 2006) or basic emotions (see T. M. Rutkowski, A. Cichocki, et al., Emotional states estimation from multichannel EEG maps. In R. Wang, E. Shen, and F. Gu, (Eds), Adv. in Cognitive Neurodynamics ICCN 2007, pages 695-698; P. Bhowmik, S. Das, et al., Emotion clustering from stimulated electroencephalographic signals using a Duffing oscillator. International Journal of Computers in Healthcare, 1(1):66-85, 2010), and to enable thought-controlled cursors on a video screen (see D. J. McFarland, W. A. Sarnacki, and J. R. Wolpaw, Brain-computer interface (BCI) operation: optimizing information transfer rates. Biological Psychology, 63(3):237-251, 2003) or thought-controlled keyboards (see A. Kübler, N. Neumann, et al., Brain-computer communication: Self-regulation of slow cortical potentials for verbal communication. Archives of Phys Med and Rehabilitation, 82:1533-1539, 2001). DARPA is funding several brain-interface programs (see US Department of Defense. Fiscal year 2010 budget estimates. Technical report, 2009).

There is a need for systems and methods that provide observational results and the logical inferences that can be drawn therefrom using a plurality of observers, at least some of whom are living, in reduced time and with improved accuracy.

### SUMMARY OF THE INVENTION

According to one aspect, the invention features a signal aggregator apparatus. The apparatus, comprises at least two signal receivers, a first of the at least two signal receivers configured to acquire a signal from a first living being, and a second of the at least two signal receivers configured to acquire a signal from a source selected from the group of sources consisting of a living being different from the first living being, a living tissue in vitro, and a machine, the at least two signal receivers each having at least one input terminal configured to receive a signal and each having at least one output terminal configured to provide the signal as output in the form of an output electrical signal; a signal processor configured to receive each of the output electrical signals from the at least two signal receivers at a respective signal processor input terminal and configured to classify each of the output electrical signals from the at least two signal receivers according to at least one classification criterion to produce an array of classified information, the signal processor configured to process the array of classified information to produce a result; and an actuator configured to receive the result and configured to perform an action selected from the group of actions consisting of displaying the result to a user of the apparatus, recording the result for future use, and performing an activity based on the result.

In one embodiment, the first living being is a human being

In another embodiment, the living being different from the first living being is also a human being.

In yet another embodiment, the living being different from the first living being is not a human being.

In still another embodiment, the at least two signal receivers comprise at least three electronic signal receivers, of which a first signal receiver is configured to acquire signals from a human being, a second signal receiver is configured to acquire signals from a living being that is not a human being, and a third signal receiver is configured to acquire signals from a machine.

In a further embodiment, at least one of the signal from the first living being and the signal from the living being different from the first living being comes from a brain of the living being or from a brain of the living being different from the first living being.

In yet a further embodiment, a selected one of the at least two signal receivers is configured to receive a signal selected from the group of signals consisting of an EEG signal, an EMG signal, an EOG signal, an EKG signal, an optical signal, a magnetic signal, a signal relating to a blood flow parameter, a signal relating to a respiratory parameter, a heart rate, an eye blinking rate, a perspiration level, a transpiration level, a sweat level, and a body temperature.

In an additional embodiment, a selected one of the at least two signal receivers is configured to receive a signal that is a signal representing a time sequence of data.

In one more embodiment, the at least two signal receivers are configured to receive signals at different times.

In still a further embodiment, the signal processor is configured to assign weights to each of the output electrical signals from the at least two signal receivers.

According to another aspect, the invention relates to a method of aggregating a plurality of signals. The method comprises the steps of acquiring a plurality of signals, the signals comprising at least signals from a first living being, and signals from a source selected from the group of sources consisting of a living being different from the first living being, a living tissue in vitro, and a machine; processing the plurality of signals to classify each of the signals according to at least one classification criterion to produce an array of classified information; processing the array of classified information to produce a result; and performing an action selected from the group of actions consisting of displaying the result to a user of the apparatus, recording the result for future use, and performing an activity based on the result.

In one embodiment, the acquired signals are acquired from more than two sources.

In another embodiment, the first living being is a human being.

In yet another embodiment, the living being different from the first living being is a human being.

In still another embodiment, the living being different from the first living being is not a human being.

In a further embodiment, the method further comprises the step of feeding the result back to at least one of the first living being, the living being different from the first living being, and the machine.

In yet a further embodiment, the result is provided in the form of a map or in the form of a distribution.

According to one aspect, the invention features a signal aggregator apparatus. The apparatus comprises at least two signal receivers, a first of the at least two signal receivers configured to acquire a signal from a source selected from the group of sources consisting of a first living being, a second living being different from the first living being, and a living tissue in vitro, and a second of the at least two signal receivers configured to acquire a signal from a source from the group consisting of a different member of the group of sources consisting of a first living being, a second living being different from the first living being, and a living tissue in vitro, and a machine, the at least two signal receivers each having at least one input terminal configured to receive a signal and each having at least one output terminal configured to provide the signal as output in the form of an output electrical signal; a signal processor configured to receive each of the output electrical signals from the at least two signal receivers at a respective signal processor input terminal and configured to classify each of the output electrical signals from the at least two signal receivers according to at least one classification criterion to produce an array of classified information, the signal processor configured to process the array of classified information to produce a result; and an actuator configured to receive the result and configured to perform an action selected from the group of actions consisting of displaying the result to a user of the apparatus, recording the result for future use, and performing an activity based on the result.

In one embodiment, the first living being is a human being.

In another embodiment, the living being different from the first living being is also a human being.

In yet another embodiment, the living being different from the first living being is not a human being.

In still another embodiment, the at least two signal receivers comprise at least three electronic signal receivers, of which a first signal receiver is configured to acquire signals from a human being, a second signal receiver is configured to acquire signals from a living being that is not a human being, and a third signal receiver is configured to acquire signals from a machine.

In a further embodiment, at least one of the signal from the first living being and the signal from the living being different from the first living being comes from a brain of the living being or from a brain of the living being different from the first living being.

In yet a further embodiment, a selected one of the at least two signal receivers is configured to receive a signal selected from the group of signals consisting of an EEG signal, an EMG signal, an EOG signal, an EKG signal, an optical signal, a magnetic signal, a signal relating to a blood flow parameter, a signal relating to a respiratory parameter, a heart rate, an eye blinking rate, a perspiration level, a transpiration level, a sweat level, and a body temperature.

In an additional embodiment, a selected one of the at least two signal receivers is configured to receive a signal that is a signal representing a time sequence of data.

In one more embodiment, the at least two signal receivers are configured to receive signals at different times.

In still a further embodiment, the signal processor is configured to assign weights to each of the output electrical signals from the at least two signal receivers.

According to another aspect, the invention relates to a method of aggregating a plurality of signals. The method comprises the steps of acquiring a plurality of signals, the signals comprising at least a signal from a source selected from the group of sources consisting of a first living being, a second living being different from the first living being, and a living tissue in vitro, and a signal from a source from the group consisting of a different member of the group of sources consisting of a first living being, a second living being different from the first living being, and a living tissue in vitro, and a machine; processing the plurality of signals to classify each of the signals according to at least one classification criterion to produce an array of classified information; processing the array of classified information to produce a result; and performing an action selected from the group of actions consisting of displaying the result to a user of the apparatus, recording the result for future use, and performing an activity based on the result.

In one embodiment, the acquired signals are acquired from more than two sources.

In another embodiment, the first living being is a human being.

In yet another embodiment, the living being different from the first living being is a human being.

In still another embodiment, the living being different from the first living being is not a human being.

In a further embodiment, the method further comprises the step of feeding the result back to at least one of the first living being, the living being different from the first living being, and the machine.

In yet a further embodiment, the result is provided in the form of a map or in the form of a distribution.

The foregoing and other objects, aspects, features, and advantages of the invention will become more apparent from the following description and from the claims.

### BRIEF DESCRIPTION OF THE DRAWINGS

The objects and features of the invention can be better understood with reference to the drawings described below, and the claims. The drawings are not necessarily to scale, emphasis instead generally being placed upon illustrating the principles of the invention. In the drawings, like numerals are used to indicate like parts throughout the various views.

FIG. 1A is a schematic diagram showing joint decision making which is robust.

FIG. 1B is a schematic diagram showing joint modeling from aggregation of partial models.

FIG. 1C is a schematic diagram showing joint analysis (such as intelligence analysis, image analysis, or analysis of data).

FIG. 1D is a schematic diagram showing high-confidence, stress-aware task allocation.

FIG. 1E is a schematic diagram showing training in environments (real or simulated) requiring rapid reactions.

FIG. 1F is a schematic diagram showing emotion-weighted voting.

FIG. 1G is another schematic diagram showing emotion-weighted voting.

FIG. 1H is a schematic diagram showing symbiotic intelligence of diverse living systems.

FIG. 1I is a schematic diagram showing man-machine intelligence.

FIG. 1J is a schematic diagram showing joint control of a vehicle or robot.

FIG. 1K is a schematic diagram showing joined/shared control using different modalities (here EEG and EMG).

FIG. 1L is a schematic diagram showing one embodiment of a signal aggregator apparatus.

FIG. 1M is a schematic diagram showing another embodiment of a signal aggregator apparatus.

FIG. 2A is a diagram that illustrates an eyes open power spectrum.

FIG. 2B is a diagram that illustrates an eyes closed power spectrum.

FIG. 3 is a diagram that illustrates a normalized power spectrum over a number of frequency beans, as a function of time. The power spectrum is associated with opening and closing of the eyes.

FIG. 4A is a diagram that illustrates Classes—‘Smile’ and ‘Laugh’ for the two subjects as a function of time.

FIG. 4B is a diagram that illustrates the intensities in the Classes—‘Smile’ and ‘Laugh’ for the two subjects as a function of time.

FIG. 4C is a diagram that illustrates an aggregated (joint) emotional assessment in several classes as a function of time, with a relative scale of intensity along a metric of “how funny” on the vertical axis.

FIG. 5 is a diagram showing an array in which elements aij describe the performance of alternative Aj against criterion Ci.

### DETAILED DESCRIPTION

In group decision making, automated means to seamlessly and quasi-instantly fuse the intelligence of a group, as well as to fuse human and machine intelligence do not exist.

Multi-attribute group decision making (MAGDM) is preferable to Yes/No individual voting. In one implementation of MAGDM, a matrix of scores is generated where elements aijl describes the performance of alternative Aj against criterion Ci, and furthermore, users are given weights that moderate their inputs. Instead of contributing with numbers, bio-signals are expected to be used to reflect user's attitude or degree of support toward an alternative or a criterion.

We now describe a method and an apparatus that automatically aggregates the biological signals from multiple living sources. In the embodiments illustrated, the living sources will often be human individuals in order to generate joint human decision making, or similar collective characteristics, such as, group-characteristic representations, joint analyses, joint control, group emotional mapping or group emotional metric/indexing. These bio-signals could be BEG, EMG, etc. collected with invasive or non-invasive means. In one embodiment this can be a multi-brain aggregator that collects brain signals such as EEG, from all the individuals in an analysis/decision group, and generates a joint analysis/decision result. However, it should be understood that in other embodiments, signals from animals, signals from a living tissue in vitro, and signals from a machine can be combined with signals from one or more human beings. We will present examples of each of such possible combinations. In addition, the systems and methods of the invention can combine signals from a plurality of different sources.

More generally, the method and the apparatus can be extended in scope to automatically determine group-characteristic properties and metrics from the aggregation of the biological signals, aggregation of the information from signals, or combination of the knowledge derived from multiple living systems and sub-systems, of same or different types. As an example, in one embodiment this can be fusion of signals produced by a number of brain-originating neurons maintained in separate Petri dishes. Another example is the aggregation of information in the EEG of a mouse and EEG of a human, in response to audio stimuli in the range 60 Hz to 90 kHz. The auditory senses of the mouse extends to 90 kHz, well above the 20 kHz upper limit for human hearing, providing additional information. Examples of use of signals from both a human source and an animal source are expected to be useful in detecting or predicting such natural phenomena as earthquakes, tsunamis and other disturbances based on geological phenomena.

The method and the apparatus can be extended in scope to automatically achieve joint decision making, joint analysis or collective information measures from a heterogeneous mixed team comprising at least one living system and one artificial system. As an example one could derive a joint decision by mixing the inputs from computers and inputs from systems that measure brain activity of a human being.

In a different example, it is expected that a combination of signals from a human interrogator, signals from a dog trained to detect illegal drugs or explosives, and signals from machine sensors can be used in combination to detect the presence illegal substances and to identify an individual who has malign intent and who is carrying or travelling with such substances. For example, the human can be a person who performs a legal interrogation of the individual in question at an airport, a border crossing, or some other checkpoint with the intent of observing both the verbal response and the demeanor of the individual being interrogated, the dog can be trained and guided (possibly by another person who is the dog's handler) to perform an olfactory survey of a package transported by the individual (either in the immediate surroundings of the individual or at a location away from the individual, for example on checked luggage at an airport, or in a vehicle driven by the individual at a border crossing), and the machine can be a scanner such as a detector designed to acquire electromagnetic signals that can be indicative of the presence of an illegal substance either on the individual, in a package transported by the individual, or in a vehicle driven by the individual or in which the individual is a passenger. In another embodiment, the machine can implement biometric detection, using for example, an image of a face, facial recognition software and a database of recorded images, fingerprint scanning, fingerprint recognition software and a database of recorded fingerprints, and/or iris images, iris recognition software and a database of recorded iris images as a way to identify a specific individual. The various examinations can be carried out simultaneously, sequentially, or at different times, in different embodiments. The combined information acquired by the human interrogator, the animal and the machine can be used to provide a more robust examination, which reduces that likelihood that an individual will successfully carry a package of illegal material past the location where the interrogation is conducted.

The methods and apparatus that aggregate information from multiple brains, as well as from brains and computers, establishes a first concrete means to generate super-intelligence (i.e. beyond human-level intelligence) by fusing the power of multiple human brains, and/or the power of human and machine intelligence. It is believed that a Multi-Brain (Mu-Brain) Aggregator can be a technology that allows a new domain of Thought Fusion (TOFU). Its objective would be to achieve super-intelligence from multiple brains, as well as from interconnected brain-machine hybrids.

When focused on brain signals, the technology described here is referred to in one embodiment as a Mu-Brain, a system that aggregates brain signals from several individuals to produce, in a very short time, a joint assessment of a complex situation, a joint decision, or to enable joint control. In one embodiment each individual would wear a head-mounted device capable of recording electroencephalographic signals (EEG), which can be collected into the Mu-Brain aggregator and then fused at either the data level, the feature level, or the decision level. Experiments illustrate the feasibility of the aggregation of brain signals from multiple individuals.

MuBrain is expected to be used for rapid collective decision-making in emergency situations, in contexts where the multi-dimensionality of complex situations requires more than simple binary voting for a robust solution, and yet there is no time to deliberate, or even communicate/share one's position/attitude from the perspective of several criteria.

The Mu-Brain technology is expected to solve the challenge of making fast joint decisions in situations imposing rapid response, in contexts where there is no time to deliberate, or even to communicate one's perspective on the situation. Also, it is expected to enable information-richer (hence, improved) joint decision making, by exploiting, for example, subconscious perceptual information. Examples of applications include automatic joint multi-perspective analyses of tactical live video streams, fast joint assessments in rapidly evolving engagement scenarios, and improved and robust task allocation in multi-human, multi-robot systems (e.g., stress-aware task allocation among operators overseeing unmanned platforms).

Particular areas of commercial interest would be group/collaborative games.

Another application is expected to be collecting statistics on the emotion of users browsing the internet. It is expected that the disclosed methods can be used to obtain a viewer's perception (e.g., ‘like’ or ° dislike') of a specific product during browsing. A directly recorded emotion is expected be of great value for learning user attitude for marketing and new product design purposes.

It is expected that aggregating brain activity information from multiple individuals can be applied to use aggregated human individual emotional intelligence and thoughts to achieve joint decisions.

The combination of bio-signals in control could be performed by aggregating the inputs for unique derived joint action, or each user can control separate degrees of freedom (e.g., shared control).

We now discuss the use of non-invasive sensing techniques, combined with sensor/information fusion techniques to pick-up group emotional intelligence, automatically and objectively. The term “group” is used because the information comes from measurement of several individuals, and the result is a characteristic not of each individual, but of the ensemble.

### Use Joint/Intelligence for Rapid Team Decisions

This technology is expected to enable a number of interesting applications, with direct and immediate benefit for DoD. A generic scenario involves a group of war-fighters who have to make a life-and-death decision on a complex problem in extremely short time. The time constraints prevent the group from sharing views and conducting discussions or debates, and rules out means to collect multi-criteria estimates to combine them, forcing a simplification to YES/NO votes (possibly weighted when combined). This is suboptimal, it eliminates sometimes critical information, and also lacks robustness. We believe that the technology described herein provides an optimal collective decision (or assessment to be used in decision-making) even in the absence of conventional means of communications (verbal or non-verbal) and even in the absence of consciously understood criteria and metrics. The present method accomplishes this result by fusing information from multiple people, as a consequence of direct analysis of the collection of their brain signals.

### The Problem

Group intelligence has the potential to exceed individual intelligence. Currently, however, it is hindered by limitations on rapidly accessing information pre-processed by individual minds, on quickly sharing information, and on combining all information properly. Collecting and processing brain-collected information in electronic form is faster and has the potential to be more complete than data collection by verbal communication methods. The essence of the novel idea is to aggregate or fuse signals from multiple brains, which will allow the collection of information from many sources.

### The Solution

The solution we propose is to collect and aggregate the information contained in brain signals from multiple individuals. This has the potential to bypass communication bottlenecks, and therefore to increase the speed of accessing and sharing the information originated by several human minds, and to enable superior collective decisions. It may also result in superior processing power by opening access to subconscious perceptual information and allowing a coordinated usage of short-memory and broader amounts of information.

A multi-brain aggregator (MuBrain) is expected to collect brain signals from the group members, in one embodiment by EEG. In other embodiments, it is expected that signals collected using other technologies will also be useful. The system and method collects the signals and brings them together, including fusing or aggregating the information. It is expected that the system will need to perform the following functions:
a. Collect and filter signals from multiple sources robustly and reliably;
b. Provide the signals in electrical form suitable for processing;
c. Analyze the signals to determine appropriate classes/dimensions to decompose the information into projection vectors along which one can cumulate or aggregate signals from multiple sources;
d. Provide analytical methods that make decisions, to validate these decisions (based on a evaluated distance from ‘truth’) and improve efficiency of this determination (reduce the distance from ‘truth’); and
e. Provide a result that can be displayed to a user, can be recorded, or can be transmitted to another apparatus for further processing or to act upon the result obtained.

Brain-Machine Interfaces

Accessing information from individual minds by measuring brain signals is a scientific field in its beginnings. Brain-sensing technologies are driven primarily by medical research, in particular focused on diagnosis. A much smaller, but growing community looks at using brain signals to extract controls. Brain invasive technologies were used to record from neural areas in monkey brains and further decoded to control remote robotic manipulators. Non-invasive techniques, mostly using EEG signals have recently been used to provide simple controls for avatars in simulated world of games or in physical robots. The current state of the art of brain control interfaces with non-invasive techniques is reaching about 2 bps (bits per second). This rather low bandwidth greatly limits area of applicability and, beyond research projects, can only show advantages over other techniques only in very specific cases, such as a person who is totally paralyzed.

In this description the focus is on EEG, despite the lower bit rates and lower spatial resolutions compared to other methods (˜1 bit per second, at accuracy of −90-95% (see J. R. Wolpaw, N. Birbaumer, et al., Brain-computer interfaces for communication and control. Clinical Neurophysiology, 113(6):767-791, 2002; B. Blankertz, G. Dornhege, et al., The Berlin brain-computer interface: EEG-based communication without subject training Neural Systems and Rehabilitation Engineering, IEEE Transactions on, 14(2):147-152, June 2006; K.-R. Müller, M. Tangermann, et al., Machine learning for real-time single-trial EEG-analysis: From brain-computer interfacing to mental state monitoring. J of Neuroscience Methods, 167(1):82-90, 2008; and R. Furlan, Igniting a brain-computer interface revolution-BCI X PRIZE. Technical Report, Singularity University, 2010). However, the Mu-Brain technology for fusing brain information from multiple individuals is not bound to EEG and is implementable with any other recording technique.

### Effective Aggregation of Multiple Brain Signals

This involves selecting which data to isolate and extract, the determination of appropriate classes/dimensions along which to cumulate/aggregate, and the functions and methods for the fusion process. To address this, one needs to combine experimental frameworks and known algorithmic tools for data fusion at different levels, which are outlined hereinbelow.

### Data Level Fusion

At this level, biological signals from multiple subjects are fused together after suitable sampling, normalization, and artifact removal. The fusion involves a variety of operators including arithmetic, relational, and logical operators. Statistics are then computed to obtain both time-domain features (e.g., average, variance, correlations/cross-correlation among different channels/subjects) and frequency domain features (e.g., power spectral density).

### Feature Level Fusion

After extraction of feature vectors from the bio-signals of each individual or source, these are aggregated, for example, by concatenation or relational operators. The aggregated feature vectors become the input of pattern recognition systems using neural networks, clustering algorithms, or template methods. For example, in an embodiment related to a workload-aware task allocation scenario, one might use the average power spectral density in the 8-13 Hz range (which is especially indicative of workload levels). In an embodiment related to a joint perception scenario, one might concatenate the spectral features of the P300 components of Event-related Potentials of each individual, and use linear discriminant analysis to detect an unexpected event.

### Decision Level Fusion

At this level, information is fused after a separate determination has been made about the intent/emotion/decision of each subject. Determinations can be aggregated by using weighted decision methods (voting techniques), classical inference, Bayesian inference, or the Dempster-Shafer's method. An example is given hereinbelow. Fusion opens avenues for the generation of super-intelligent systems and for the fusion of human and machine intelligence.

### Applications

In addition to applications already described, the Mu-Brain technology is expected to provide an unprecedented advantage in several scenarios.

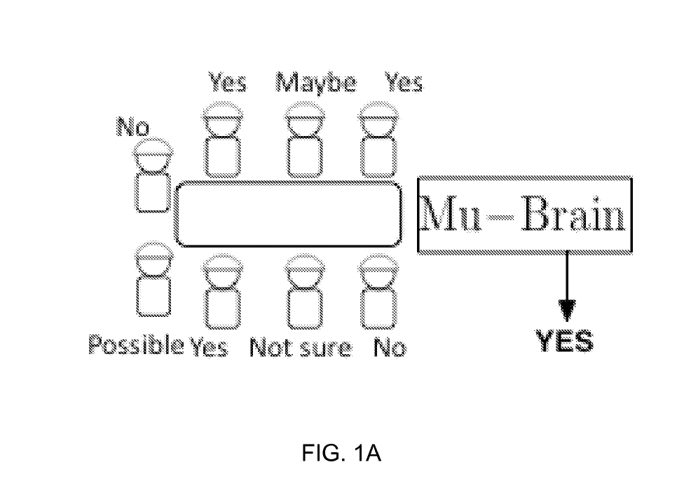

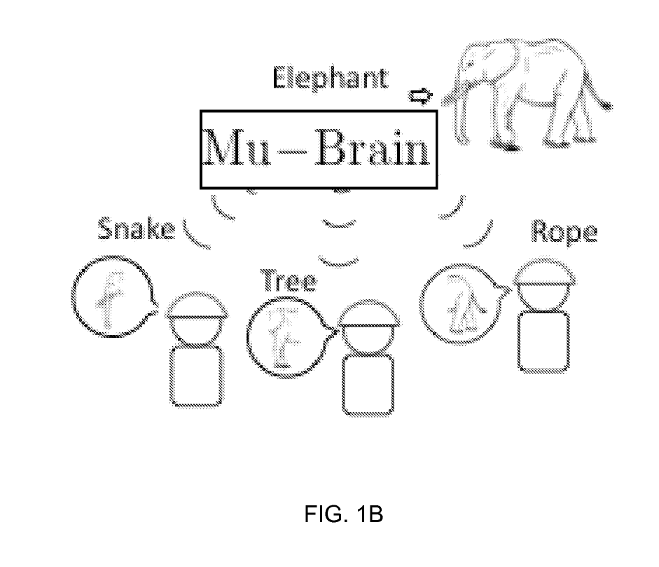

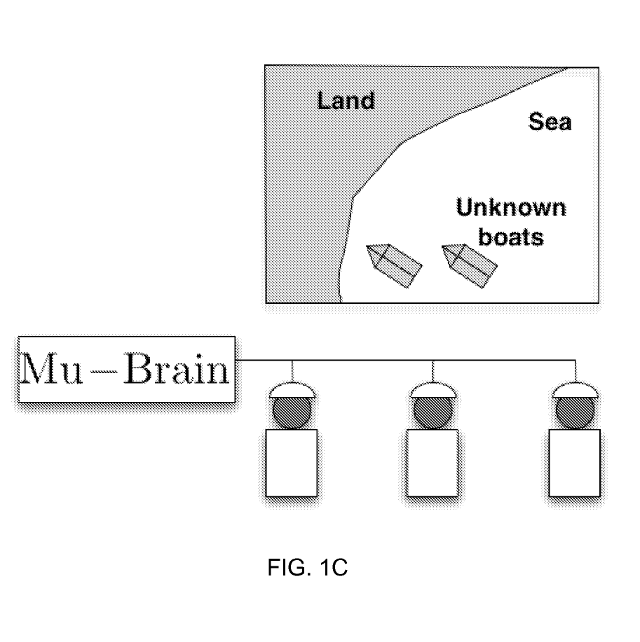

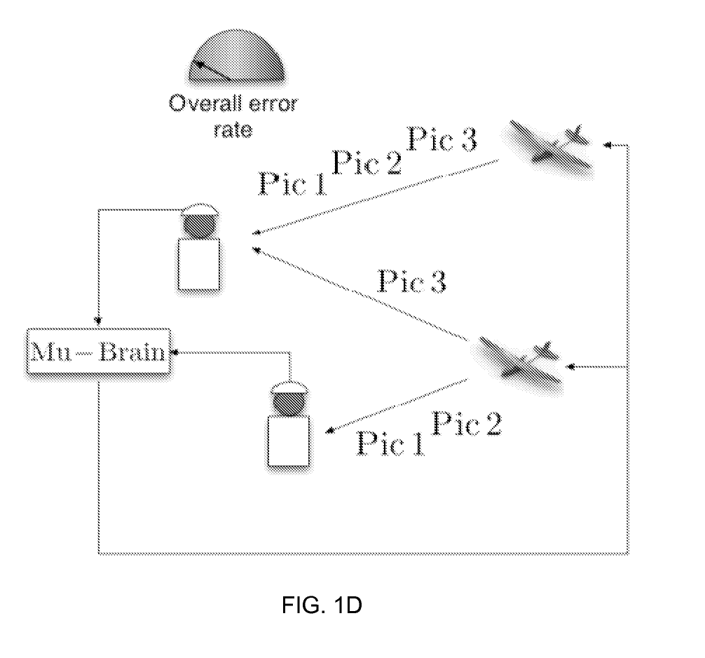

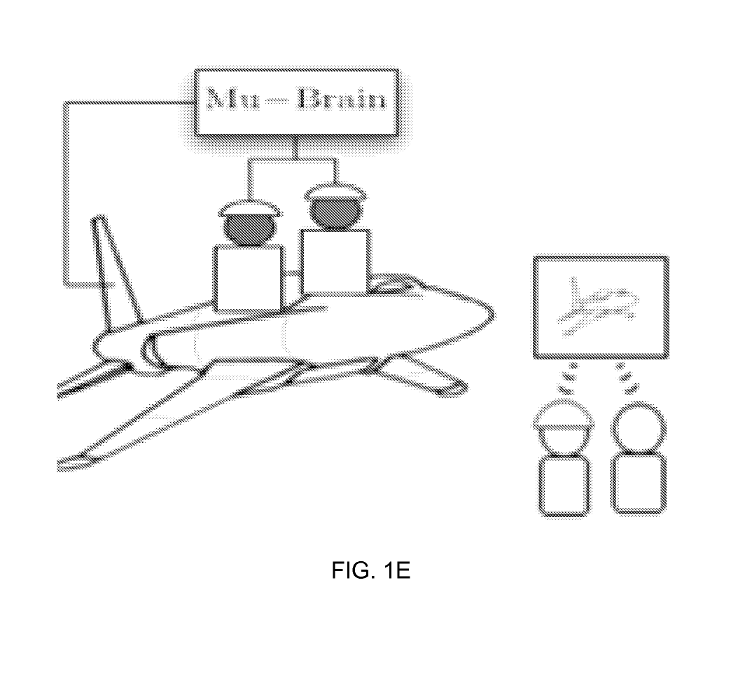

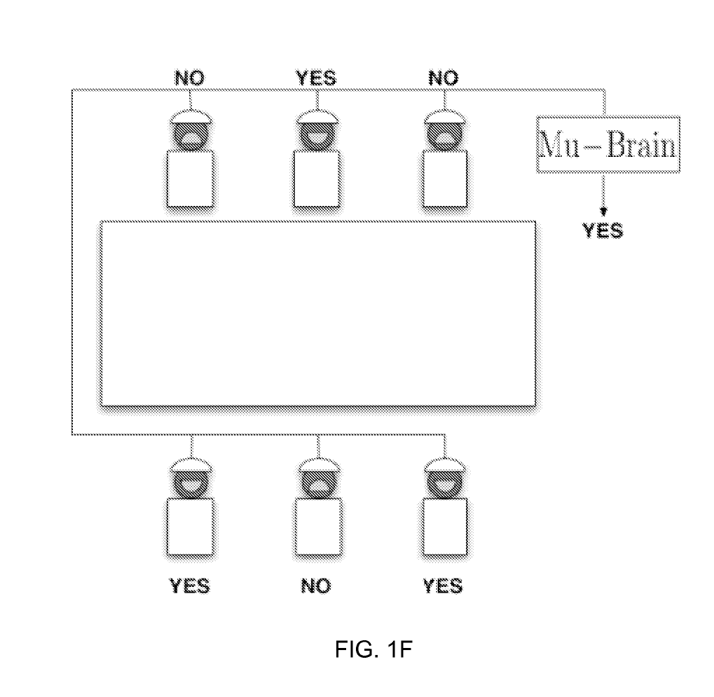

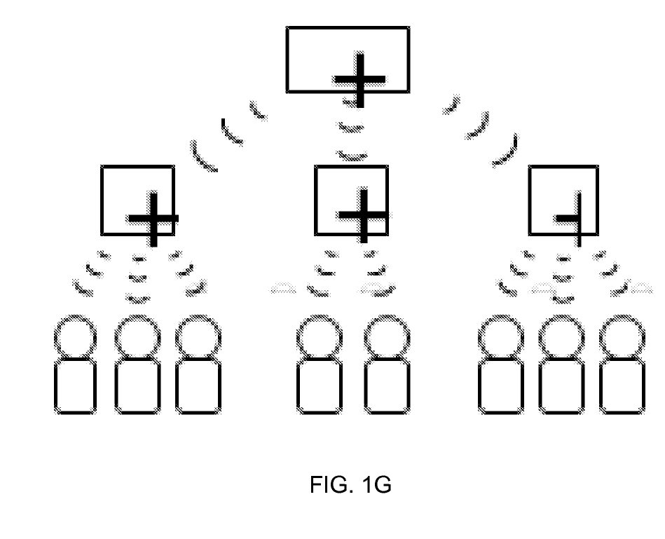

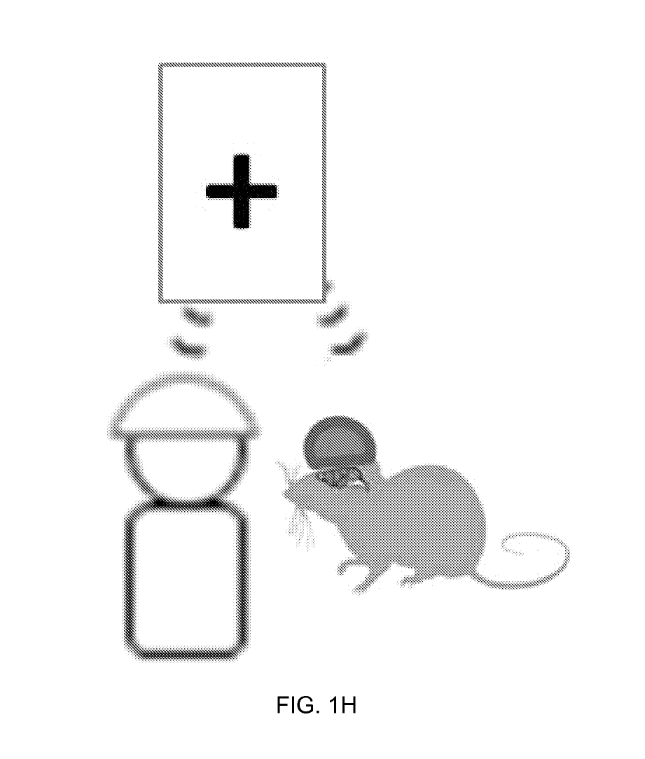

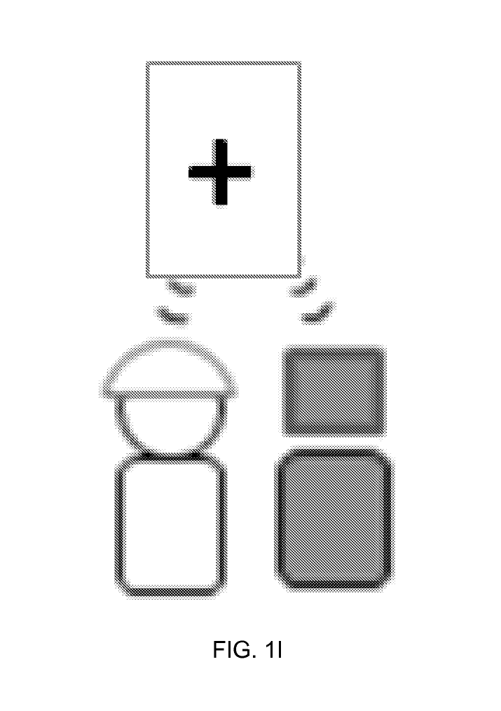

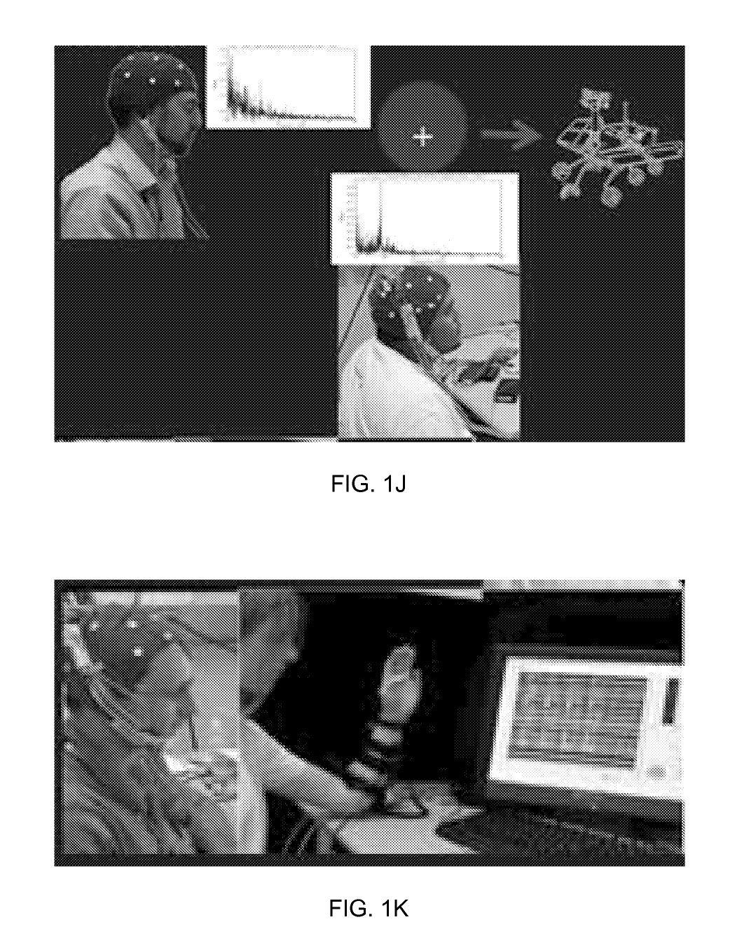

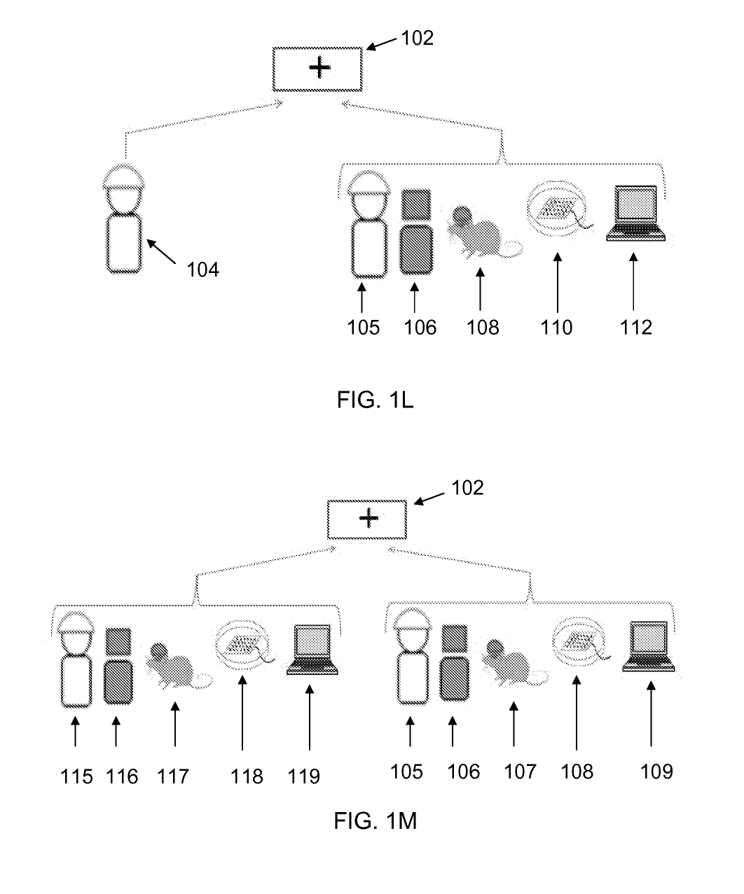

Seamless autonomous joint decision making, (see FIG. 1A) based on multi-perspective group intelligence. It is superior to cases when time constraints prohibit sharing positions/views, and force Yes/No binary votes and majority-based decision rules (e.g., rapid threat assessment scenarios), which is sub-optimal, eliminates critical information and lacks robustness).

Improved modeling from aggregation of partial models (see FIG. 1B). This is exemplified by the story of “Six blind people and the elephant,” each of whom thinks that the elephant has a different form based on their individual experience of touching a different part of the elephant. A Mu-Brain has the potential to create a model that cannot be constructed by using the capabilities of individuals alone.

Joint analysis, such as joint intelligence/image based on group (emotional) intelligence (see FIG. 1C). Various people watching the same video notice/focus on different aspects—Mu-Brains are expected to automatically fuse their perceptions in real-time, and effectively enable perceptions on more than 4-6 “memory chunks,” which is the upper limit for individual beings (see G. A. Miller, The magical number seven plus or minus two: Some limits on our capacity for processing information. Psychological Review, 63:81-97, 1956; N. Cowan, The magical number 4 in short-term memory: A reconsideration of mental storage capacity. Behavioral and Brain Sciences, 24:87-114, 2001).

High-confidence, stress-aware task allocation with multiple humans in the loop (see FIG. 1D).

Training (or operations) in environments requiring rapid reactions or feedback. An instructor (emotional) intelligence may override wrong commands of pilot trainee, may flag dangers/alarms, and may provide real-time feedback (see FIG. 1E).

Emotion-weighted voting for objective decision making (see FIG. 1F).

Context-situational awareness and evaluation based on multi-perspective EmInt of all fighters in the field. This is an extension from council room to battlefield.

Collective social aggregated EmInt. This is an extension of multi-dimensional voting to larger groups in social contexts (large scale participation).

Participants can be located at any distance. Long distance does not represent a barrier. Using Internet/satellite mediated planetary-scale communication systems, an EmInt system can be developed that does not rely on words, but rather is a planet-scale emotion sharing. EEG from headsets plugged directly into cellphones, laptop computers, or similar web-capable hardware.

### Aggregation Modalities (See FIG. 1G)

Hierarchical aggregation This scenario is one in which the flow of decision-making requires changes/refinement on deep decision trees, with complex decisions involving sub-decisions, each of a different type and criteria. The context is expected to be one of decisions at the level of chief-of-staff, using recommendations from multiple groups, of heterogeneous nature and different areas of expertise. The recommendations/decisions at lower levels of hierarchy are performed on characteristics specific to the sub-group.

Distributed aggregation—social media contribution model This scenario is one in which the flow of decision-making requires changes/refinement on deep decision trees, with complex decisions involving sub-decisions, each of a different type and criteria. The context is expected to be one of decisions at the level of chief-of-staff, using recommendations from multiple groups, of heterogeneous nature and different areas of expertise. The recommendations/decisions at lower levels of hierarchy are performed on characteristics specific to the sub-group.

Neighborhood-based joint EmInt Fusion A decision is fused using input from one or more neighboring zones.

Symbiosis of heterogeneous living systems. (see FIG. 1H)

Joint/Symbiotic Man-Machine Intelligence (see FIG. 1I) This includes scenarios in which a machine is added as a data source. Aggregation is expected to happen not at signal level but at a higher (e.g., feature) level. For example on the Intel Analysis for Individual Detection (or behavior ID) in a crowd, the result of a face tracking algorithm (or behavior classification) and the result of a human analyst looking for a certain face/individual (or behavior).

Joint vehicle/robot control using more ‘drivers’ (see FIG. 1J).

Joint/shared control using different modalities (from the same or a different ‘driver’) e.g., using both EEG and EMG inputs (see FIG. 1K).

The Mu-Brain is a first step towards thought fusion, by which super-intelligence from multiple brains, as well as from interconnected brain-machine hybrids is expected to be achieved. Fusing brain signals adds an extra dimension to brain-computer interfaces.

We now describe a way to achieve group emotional intelligence. This is referred to as “group” emotional intelligence because the information comes from EEG measurements on a plurality of individuals, and the result is a characteristic of the ensemble. The term “emotional” is used because the focus is on detecting and aggregating basic emotions—which are detectable by electroencephalographic signals. The following is a set of scenarios of applicability (using simulation/videogame type environment to provide the input) that are expected to be operable.

### Scenario 1—Rapid Multi-Perspective Threat Assessment

A group of warfighters discovers a potentially hazardous object. The Mu-Brain is expected to measure and aggregate fear levels from each individual, and is expected to produce, in seconds, a joint assessment of the threat.

### Scenario 2—Stress-Aware Task Allocation for Remote Reconnaissance

Several unmanned aerial vehicles (UAVs) take pictures of spatially-localized and dynamically-generated points of interest, which are then sent to human operators with the aim of detecting threats. The Mu-Brain is expected to measure and compare levels of stress in the human operators, and is expected to dynamically adjust task allocation.

Scenario 3—Collaborative Perception of Unexpected Events: a Group of Analysts Inspects a Video by Focusing on Different Aspects.

The Mu-Brain is expected to aggregate their brain signals to detect if any of the analysts is surprised by an unexpected event. This triggers specific alarms (depending on the events) that cue other analysts and speeds up the overall assessment.

The aim of the first and third scenarios is to produce a result that is the outcome of collaboration, and is unachievable by measurement/processing in a single human mind, while the aim of the second scenario is to obtain optimal collective behavior.

The system can also include electromyographic (EMG) arrays for human-computer interfaces and a suite of software tools to analyze electrocardiographic (ECG) waveforms from sensor arrays, including software filtering (bandpass filters, Principal Component Analysis, Independent Component Analysis, and Wavelet transforms), beat detection and R-R interval timing, automatic delineation algorithms (to extract information on waveform P, QRS, and T components), and pattern recognition (template matching, cross-correlation methods, nonlinear methods, and model-based tracking with an extended Kalman filter) to classify waveform morphology.

### Other Applications

### Decision-Making at Various DOD Levels

A plethora of Department of Defense (DoD) applications directly depend on miniaturization of hardware. Warriors can be provided with wearable hardware that can provide total integration into the digital battlefield, real-time health monitoring, wound assessment, implant drug dozing and release.

Various commercial or academic uses can include shared/multi-user games, analysis using collective intelligence; team or collective design, synthesis and/or planning, collaborative tools, feedback among group members, and man-machine joint/fused decision-making, planning, and/or analysis.

Methods for Collecting and Aggregating Brain Signals from Multiple Individuals

### Signal Collection

FIG. 1L is a schematic diagram showing one embodiment of a signal aggregator apparatus 102. Signal aggregator apparatus 102 in some embodiments in an instrument based on a general purpose programmable computer and can include a plurality of signal receivers, a signal processor, and an actuator. The apparatus comprises at least two signal receivers. A first of the at least two signal receivers is configured to acquire a signal from a first living being 104, such as a human being. A second of the at least two signal receivers is configured to acquire a signal from a source selected from the group of sources consisting of a living being different from the first living being, such as another human being 105, a machine 106, an animal such as mouse 108, a living tissue in vitro 110, and a machine 112, such as a computer. The at least two signal receivers each has at least one input terminal configured to receive a signal and each has at least one output terminal configured to provide the signal as output in the form of an output electrical signal. The apparatus 102 includes a signal processor configured to receive each of the output electrical signals from the at least two signal receivers at a respective signal processor input terminal and configured to classify each of the output electrical signals from the at least two signal receivers according to at least one classification criterion to produce an array of classified information, the signal processor configured to process the array of classified information to produce a result. The apparatus 102 includes an actuator configured to receive the result and configured to perform an action selected from the group of actions consisting of displaying the result to a user of the apparatus, recording the result for future use, and performing an activity based on the result.

In some embodiments, the apparatus can be used to collect signals from a first source at a first time, and from a second source where the second source is the same individual as the first source but with signals taken at a later time (e.g., after some time has elapsed) so that the two sets of signals can be compared to see how the individual (or the individual's perception) has changed with time.

FIG. 1M is a schematic diagram showing another embodiment of a signal aggregator apparatus. Signal aggregator apparatus 102 in some embodiments in an instrument based on a general purpose programmable computer and can include a plurality of signal receivers, a signal processor, and an actuator. The apparatus comprises at least two signal receivers. A first of the at least two signal receivers is configured to acquire a signal from a source selected from the group of sources consisting of a living being 115, such as a human being, a living being different from the first living being, a machine 116 such as a video or audio input, an animal such as mouse 117, a living tissue in vitro 118, and a machine 116, a machine 119, such as a computer. A second of the at least two signal receivers is configured to acquire a signal from a source selected from the group of sources consisting of a living being different from the first living being, such as another human being 105, a machine 106 such as a video or audio input, an animal such as mouse 107, a living tissue in vitro 108, and a machine 109, such as a computer. The at least two signal receivers each has at least one input terminal configured to receive a signal and each has at least one output terminal configured to provide the signal as output in the form of an output electrical signal. The apparatus 102 includes a signal processor configured to receive each of the output electrical signals from the at least two signal receivers at a respective signal processor input terminal and configured to classify each of the output electrical signals from the at least two signal receivers according to at least one classification criterion to produce an array of classified information, the signal processor configured to process the array of classified information to produce a result. The apparatus 102 includes an actuator configured to receive the result and configured to perform an action selected from the group of actions consisting of displaying the result to a user of the apparatus, recording the result for future use, and performing an activity based on the result.

We used EEG collection caps/headsets, with a varying number of sensors/channels. Some were built at the Jet Propulsion Laboratory and some were available commercially, such as the EMOTIV EPOC headset with 14 sensors (EMOTIVE, San Francisco, Calif.). Previous reported work confirms the ability to detect simple focused thoughts, emotions and expression, from EEG and/or additional built in sensors in the EMOTIV cap. This includes EMG and EOG sensors.

Past research indicates that emotions have been identified with higher agreement, for example using discrete wavelet transforms. The literature indicates the possibility of using wavelet transform based feature extraction to assessing the human emotions from EEG signal.

### Aggregation at Signal Level

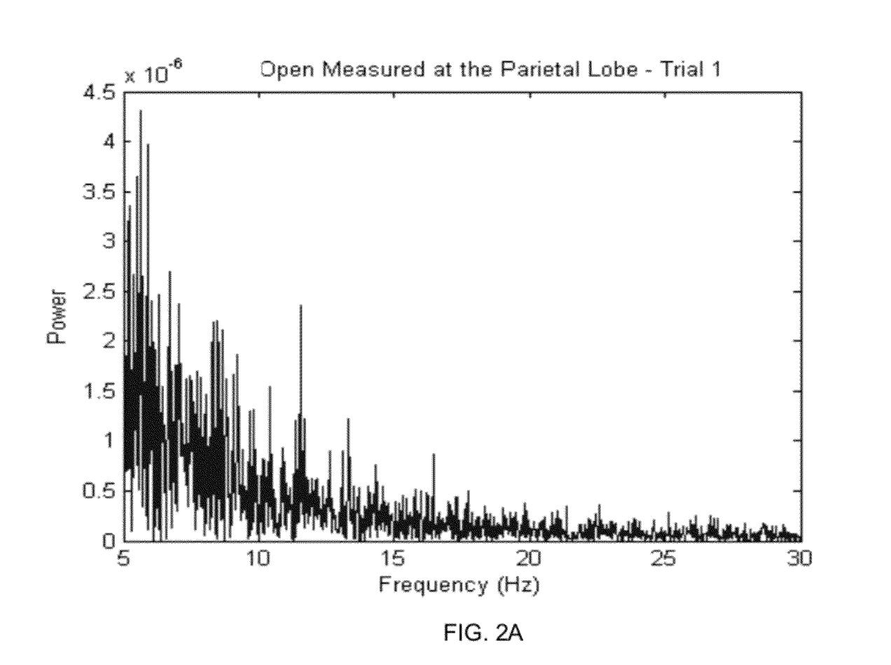

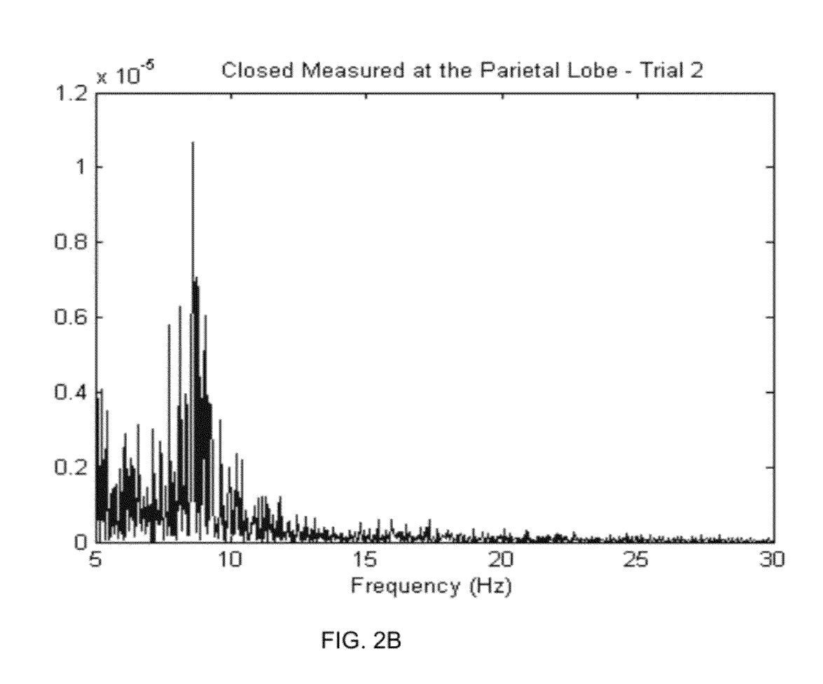

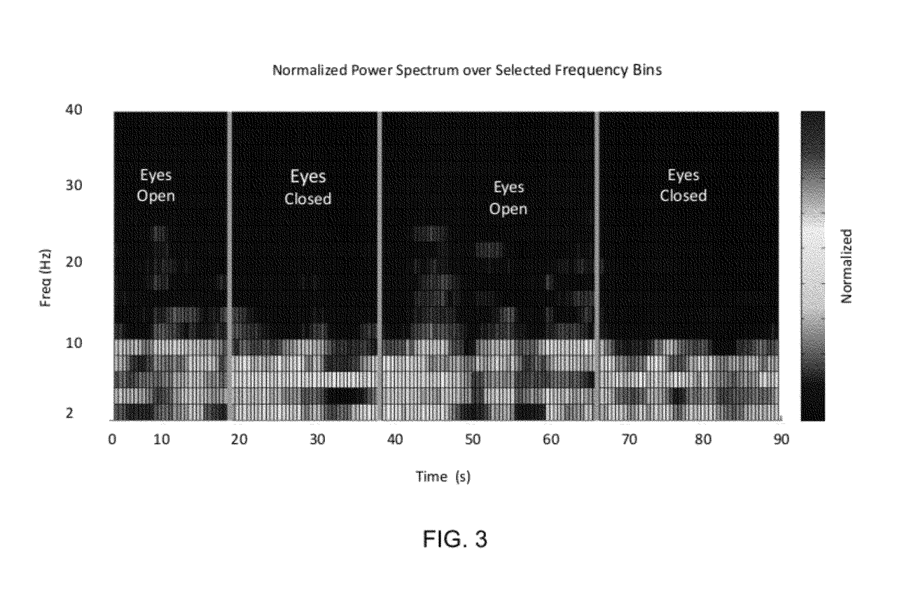

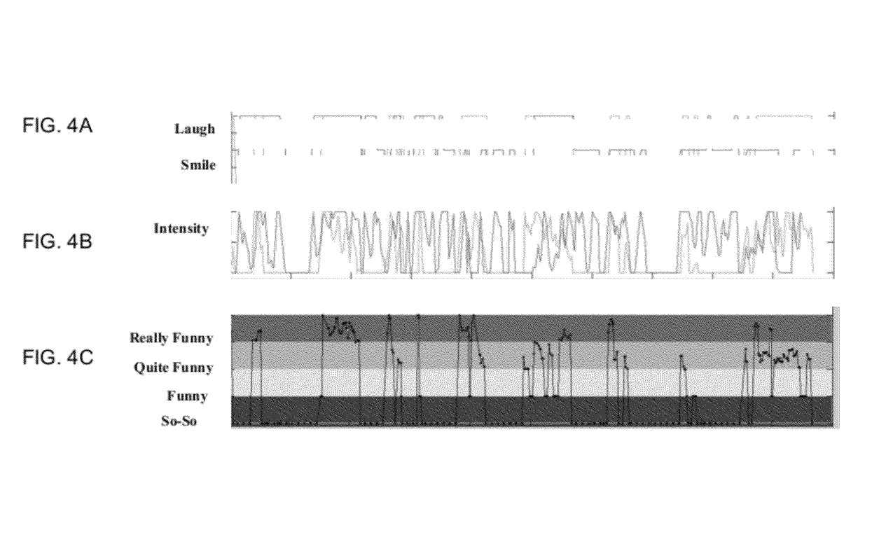

An example of this context is to combine the power level in a specific frequency band. Figure below show power distribution in frequency for 2 cases: eyes open and eyes closed. Most people respond to lack of excitation by light (dark room, eyes closed) with a peak in recorded signal of certain area as in FIG. 2A and FIG. 2B.

FIG. 2A is a diagram that illustrates an eyes open power spectrum, showing a difference in 2 EEG associated with 2 brains states, in this case associated with a reaction to light, simply obtained here by opening/closing the eyes.

FIG. 2B is a diagram that illustrates an eyes closed power spectrum.

In this context one can consider aggregation at signal level to be obtained by summing the integral of power in a specific frequency interval, for example in interval 6-12 Hertz. Among the alternatives to the simple sum is the use of a weighted sum.

Signal aggregation can be made after further processing and can involve for example the normalized power spectrum over frequency bins. One can select specific bins in which the summation of contribution from different users is made.

### Aggregation at Feature Level

Building a Vector from Components Derived from Individual Bio-Signals.

The state vector that characterized the group could include components contributed by various individuals. For example VGroup={f(A1, A2), fB3, f(C1,C2,C3), D4}, where the number is the index of the person and A-D is the specific feature or class.

The following example illustrates a joint evaluation using biosignals. Biosignals were provided by two Emotiv EPOC headsets, which use EEG and EMG sensors. In this examples the fusion is done at feature/class level, specificially after the software decoding classes of signals for expressions of smile and laugh (and neutral), with degrees of intensity associated to these classes (e.g. it classifies ‘laugh’ and ‘0.7’—a fraction number between 0 and 1—as an indicator of how strong laugh).

The test application was the joint evaluation of how humorous a set of images were to the subjects to which they were presented. We used a set of slides with humorous cartoons, images being seen by the two subjects that wore EMOTIV headsets, the bio-signals being collected and aggregated by software running on a laptop.

The joint evaluation of a piece of information (as derived from an aggregation based on rules of the following type:

If only one of the two subjects is smiling then image is So-So; If both are smiling than Image is Funny; If both are laughing then image is really funny, etc. In more formal way the rules are of IF-THEN type:

IF User1 is Smiling AND User2 is Laughing THEN the image was Quite Funny The rules are summarized in Table 1.

TABLE 1

In2

| In1 | Neutral | Smile | Laugh |
|---|---|---|---|
| Neutral | Neutral | So-So | Funny |
| Smile | So-So | Funny | Quite Funny |
| Laugh | Funny | Quite Funny | Real Funny |

TABLE 2
Convention for decoding of the output

| | Class | | |
|---|---|---|---|
| Output: | relative | | Overall/ |
| Joint | Intensity/ | | absolute |
| evaluation | degree | Added term | intensity |
| Real Funny | 0-1 | +3 | 3-4 |
| Quite Funny | 0-1 | +2 | 2-3 |
| Funny | 0-1 | +1 | 1-2 |
| So-So | 0-1 | +0 | 0-1 |
| Neutral | 0-1 | | 0 |

### Rule Processing

The conjunction AND in the IF-THEN rule can be interpreted in various ways. In this example we consider the rules describing a fuzzy system, and the conjunction AND taken as a MIN or PRODUCT of the two numbers. An AVERAGE can also be attempted in a less formal setting.

In this example the output was calculated as a minimim of the two inputs, O=MIN(I1, I2) where I1 and I2 were numbers in [0,1] indicating a degree or intensity of membership in a class.

To assign a numerical index for joined output (an overall evaluation of how humorous an image was) an ordering was created in such a way that a continuous increase was possible, for example 1 of So-So funny (funny) had as a right limit with 0 “Funny” To obtain the overall intensity, one adds the relative position in a class to the max scale of the previous class, as shown in Table 1 right, last column.

Multi-Attribute Decision Making with Bio-Signal Input

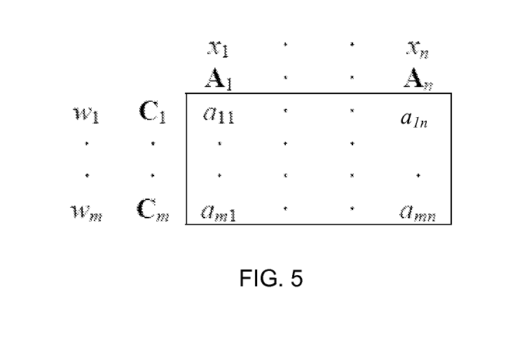

The multi-attribute decision making (MADM) involves a number of criteria C and alternatives A (say m and n, respectively). A decision table has rows belonging to a criterion and columns to describe performance of an alternative. Thus, a score aij describes the performance of alternative Aj against criterion Ci. See FIG. 5. Assume that a higher score value means a better performance. Weights wi are assigned to the criteria, and indicate the relative importance of criteria Ci to the decision. The weights of the criteria are usually determined on subjective basis. In our proposed method these can be obtained directly from bio-signals. The result can be the result of individuals or result of a group aggregation.

There are several known approaches to extend the basic MADM techniques for the case of group decisions. Assume group members D1, . . . , Dl. Individual preferences for each of the criteria are expressed as weights wi, which is assigned to criterion Ci by decision maker Dk. In one embodiment the weights come from bio-signals. Different priority levels are used for weighing the criteria and for qualifying alternatives against them. Decision makers will be allocated voting powers for weighing each criterion. These also can be derived or aggregated from bio-signals.

This allows one to calculate the group utility (group ranking value) for a certain alternative Aj. The aggregate of individual weights of criterion Ci will determine the group weight Wi by using a weighted average formula.

The group qualification Qij of alternative Aj against criterion Ci is obtained by a weighted mean of the aij. Finally the group utility Uj of Aj is determined as the weighted algebraic mean of the aggregated qualification values with the aggregated weights. The best alternative of group decision is the one associated with the highest group utility.

### DEFINITIONS

As used herein the term “living being” describes a being such as a human, an animal, or a single- or multiple-cell aggregation of living material that lives autonomously without external intervention.

As used herein the term “living tissue in vitro” describes biologically active living matter such as a being, an organ of a being, or a single- or multiple-cell aggregation of living material that lives with the assistance of external intervention (beyond what the living matter can provide for itself) without which the biologically active living matter would not survive, such as in the form of a supply of a necessary gas (e.g., pulmonary intervention), a supply of nutrition and removal of waste products (e.g., circulatory intervention), or similar external intervention.

Unless otherwise explicitly recited herein, any reference to an electronic signal or an electromagnetic signal (or their equivalents) is to be understood as referring to a non-volatile electronic signal or a non-volatile electromagnetic signal.

As used herein, the discussion of acquiring signals from a living being or from living tissue in vitro is intended to describe a legally permissible recording of signals that emanate from the living being or from the living tissue. For example, in the United States, some states (example, the Commonwealth of Massachusetts) require the consent of each party to a conversation for a legal recording of the conversation to be made, while other states (example, the State of New York) permit a legal recording of a conversation to be made when one party to the conversation consents to the recording.

Recording the results from an operation or data acquisition, such as for example, recording results at a particular frequency or wavelength, is understood to mean and is defined herein as writing output data in a non-transitory manner to a storage element, to a machine-readable storage medium, or to a storage device. Non-transitory machine-readable storage media that can be used in the invention include electronic, magnetic and/or optical storage media, such as magnetic floppy disks and hard disks; a DVD drive, a CD drive that in some embodiments can employ DVD disks, any of CD-ROM disks (i.e., read-only optical storage disks), CD-R disks (i.e., write-once, read-many optical storage disks), and CD-RW disks (i.e., rewriteable optical storage disks); and electronic storage media, such as RAM, ROM, EPROM, Compact Flash cards, PCMCIA cards, or alternatively SD or SDIO memory; and the electronic components (e.g., floppy disk drive, DVD drive, CD/CD-R/CD-RW drive, or Compact Flash/PCMCIA/SD adapter) that accommodate and read from and/or write to the storage media. Unless otherwise explicitly recited, any reference herein to “record” or “recording” is understood to refer to a non-transitory record or a non-transitory recording.

As is known to those of skill in the machine-readable storage media arts, new media and formats for data storage are continually being devised, and any convenient, commercially available storage medium and corresponding read/write device that may become available in the future is likely to be appropriate for use, especially if it provides any of a greater storage capacity, a higher access speed, a smaller size, and a lower cost per bit of stored information. Well known older machine-readable media are also available for use under certain conditions, such as punched paper tape or cards, magnetic recording on tape or wire, optical or magnetic reading of printed characters (e.g., OCR and magnetically encoded symbols) and machine-readable symbols such as one and two dimensional bar codes. Recording image data for later use (e.g., writing an image to memory or to digital memory) can be performed to enable the use of the recorded information as output, as data for display to a user, or as data to be made available for later use. Such digital memory elements or chips can be standalone memory devices, or can be incorporated within a device of interest. “Writing output data” or “writing an image to memory” is defined herein as including writing transformed data to registers within a microcomputer.

“Microcomputer” is defined herein as synonymous with microprocessor, microcontroller, and digital signal processor (“DSP”). It is understood that memory used by the microcomputer, including for example instructions for data processing coded as “firmware” can reside in memory physically inside of a microcomputer chip or in memory external to the microcomputer or in a combination of internal and external memory. Similarly, analog signals can be digitized by a standalone analog to digital converter (“ADC”) or one or more ADCs or multiplexed ADC channels can reside within a microcomputer package. It is also understood that field programmable array (“FPGA”) chips or application specific integrated circuits (“ASIC”) chips can perform microcomputer functions, either in hardware logic, software emulation of a microcomputer, or by a combination of the two. Apparatus having any of the inventive features described herein can operate entirely on one microcomputer or can include more than one microcomputer.

General purpose programmable computers useful for controlling instrumentation, recording signals and analyzing signals or data according to the present description can be any of a personal computer (PC), a microprocessor based computer, a portable computer, or other type of processing device. The general purpose programmable computer typically comprises a central processing unit, a storage or memory unit that can record and read information and programs using machine-readable storage media, a communication terminal such as a wired communication device or a wireless communication device, an output device such as a display terminal, and an input device such as a keyboard. The display terminal can be a touch screen display, in which case it can function as both a display device and an input device. Different and/or additional input devices can be present such as a pointing device, such as a mouse or a joystick, and different or additional output devices can be present such as an enunciator, for example a speaker, a second display, or a printer. The computer can run any one of a variety of operating systems, such as for example, any one of several versions of Windows, or of MacOS, or of UNIX, or of Linux. Computational results obtained in the operation of the general purpose computer can be stored for later use, and/or can be displayed to a user. At the very least, each microprocessor-based general purpose computer has registers that store the results of each computational step within the microprocessor, which results are then commonly stored in cache memory for later use.

Many functions of electrical and electronic apparatus can be implemented in hardware (for example, hard-wired logic), in software (for example, logic encoded in a program operating on a general purpose processor), and in firmware (for example, logic encoded in a non-volatile memory that is invoked for operation on a processor as required). The present invention contemplates the substitution of one implementation of hardware, firmware and software for another implementation of the equivalent functionality using a different one of hardware, firmware and software. To the extent that an implementation can be represented mathematically by a transfer function, that is, a specified response is generated at an output terminal for a specific excitation applied to an input terminal of a “black box” exhibiting the transfer function, any implementation of the transfer function, including any combination of hardware, firmware and software implementations of portions or segments of the transfer function, is contemplated herein, so long as at least some of the implementation is performed in hardware.

### THEORETICAL DISCUSSION

Although the theoretical description given herein is thought to be correct, the operation of the devices described and claimed herein does not depend upon the accuracy or validity of the theoretical description. That is, later theoretical developments that may explain the observed results on a basis different from the theory presented herein will not detract from the inventions described herein.

Any patent, patent application, or publication identified in the specification is hereby incorporated by reference herein in its entirety. Any material, or portion thereof, that is said to be incorporated by reference herein, but which conflicts with existing definitions, statements, or other disclosure material explicitly set forth herein is only incorporated to the extent that no conflict arises between that incorporated material and the present disclosure material. In the event of a conflict, the conflict is to be resolved in favor of the present disclosure as the preferred disclosure.

While the present invention has been particularly shown and described with reference to the preferred mode as illustrated in the drawing, it will be understood by one skilled in the art that various changes in detail may be affected therein without departing from the spirit and scope of the invention as defined by the claims.

What is claimed is:

1. A signal aggregator apparatus, comprising:
at least two signal receivers, a first of said at least two signal receivers configured to acquire a signal from a first living being, and a second of said at least two signal receivers configured to acquire a signal from a source selected from the group of sources consisting of a living being different from said first living being, a living tissue in vitro, and a machine, said at least two signal receivers each having at least one input terminal configured to receive a signal and each having at least one output terminal configured to provide said signal as output in the form of an output electrical signal;
a signal processor configured to receive each of said output electrical signals from said at least two signal receivers at a respective signal processor input terminal and configured to classify each of said output electrical signals from said at least two signal receivers according to at least one classification criterion to produce an array of classified information, said signal processor configured to process said array of classified information to produce a result; and
an actuator configured to receive said result and configured to perform an action selected from the group of actions consisting of displaying said result to a user of said apparatus, recording said result for future use, and performing an activity based on said result.

2. The signal aggregator apparatus of claim 1, wherein said first living being is a human being.

3. The signal aggregator apparatus of claim 2, wherein said living being different from said first living being is also a human being.

4. The signal aggregator apparatus of claim 2, wherein said living being different from said first living being is not a human being.

5. The signal aggregator apparatus of claim 1, wherein said at least two signal receivers comprise at least three electronic signal receivers, of which a first signal receiver is configured to acquire signals from a human being, a second signal receiver is configured to acquire signals from a living being that is not a human being, and a third signal receiver is configured to acquire signals from a machine.

6. The signal aggregator apparatus of claim 1, wherein at least one of said signal from said first living being and said signal from said living being different from said first living being comes from a brain of said living being or from a brain of said living being different from said first living being.

7. The signal aggregator apparatus of claim 1, wherein a selected one of said at least two signal receivers is configured to receive a signal selected from the group of signals consisting of an EEG signal, an EMG signal, an EOG signal, an EKG signal, an optical signal, a magnetic signal, a signal relating to a blood flow parameter, a signal relating to a respiratory parameter, a heart rate, an eye blinking rate, a perspiration level, a transpiration level, a sweat level, and a body temperature

8. The signal aggregator apparatus of claim 1, wherein a selected one of said at least two signal receivers is configured to receive a signal that is a signal representing a time sequence of data.

9. The signal aggregator apparatus of claim 1, wherein said at least two signal receivers are configured to receive signals at different times.

10. The signal aggregator apparatus of claim 1, wherein said signal processor is configured to assign weights to each of said output electrical signals from said at least two signal receivers.

11. A method of aggregating a plurality of signals, comprising the steps of:
acquiring a plurality of signals, said signals comprising at least signals from a first living being, and signals from a source selected from the group of sources consisting of a living being different from said first living being, a living tissue in vitro, and a machine;
processing said plurality of signals to classify each of said signals according to at least one classification criterion to produce an array of classified information;
processing said array of classified information to produce a result; and
performing an action selected from the group of actions consisting of displaying said result to a user of said apparatus, recording said result for future use, and performing an activity based on said result.

12. The method of aggregating a plurality of signals of claim 11, wherein said acquired signals are acquired from more than two sources.

13. The method of aggregating a plurality of signals of claim 11, wherein said first living being is a human being.

14. The method of aggregating a plurality of signals of claim 13, wherein said living being different from said first living being is a human being.

15. The method of aggregating a plurality of signals of claim 13, wherein said living being different from said first living being is not a human being.

16. The method of aggregating a plurality of signals of claim 11, wherein said method further comprises the step of feeding said result back to at least one of said first living being, said living being different from said first living being, and said machine.

17. The method of aggregating a plurality of signals of claim 11, wherein said result is provided in the form of a map or in the form of a distribution.
